(19) United States
(12) Patent Application Publication
(10) Pub. No.: US 2025/0081044 A1
(43) Pub. Date: Mar. 6, 2025

(54) SYSTEM, METHOD, AND COMPUTER PROGRAM FOR EVALUATING NETWORK CONDITIONS

(71) Applicant: Rakuten Mobile, Inc., Tokyo (JP)

(72) Inventor: Sandeep Mani TRIPATHI, Tokyo (JP)

(73) Assignee: Rakuten Mobile, Inc., Tokyo (JP)

(21) Appl. No.: 18/270,536

(22) PCT Filed: May 30, 2023
(86) PCT No.: PCT/US2023/023835

§ 371 Date: Jun. 30, 2023

(51) Int. Cl. H04W 28/22; H04L 1/00; H04W 24/02

(52) U.S. Cl. CPC H04W 28/22; H04L 1/0003; H04L 1/0009; H04W 24/02

(57) ABSTRACT

Provided are system, method, and device for evaluating network conditions. According to embodiments, the system may include: a memory storage storing computer-executable instructions; and at least one processor communicatively coupled to the memory storage, wherein the at least one processor may be configured to execute the instructions to: determine a condition of a communication channel during at least one time slot of a plurality of time slots; and adapt a transmission property of data during the at least one time slot based on the condition of the communication channel during a corresponding time slot.

### TECHNICAL FIELD

Systems, methods, and computer programs consistent with example embodiments of the present disclosure relate to a telecommunication network, and more specifically, relate to evaluation of network conditions in a telecommunication network.

### BACKGROUND

A condition of a communication channel between a user's user equipment (UE) and a base station plays an important role in a telecommunication network. This is because such condition can affect how well can the UE receive and decode downlink (DL) data transmitted from the base station, and how well can the base station receive and decode uplink (UL) data transmitted from the UE. Such condition may also be indicative of the distance between the UE and the base station, as well as the interference and noise in the channel.

In the related art, the condition of the communication channel may be determined by the base station. Specifically, the UE may transmit a Channel Status Information Report (CSI Report) to the base station based on a Channel Status Information Reference Signal (CSI-RS) received from the base station. The CSI Report may include, among other things, a Channel Quality Indicator (CQI) indicating a quality (condition) of the communication channel estimated by the UE.

The base station may then determine a Modulation and Coding Scheme (MCS) that is appropriate for such condition of the communication channel based on the received CQI, and transmit a DL data or instruct the UE to transmit a UL data according to the determined MCS. The MCS may specify a modulation and code rate for transmission of the UL and DL data between the UE and the base station.

Nevertheless, the above approach for determining the condition of the communication channel in the related art have the following short comings. It is possible for the CQI estimated by the UE to be inaccurate or inappropriate, due to several factors such as changing conditions, different estimation method, etc. Subsequently, the MCS determined by the base station may not be appropriate for the actual condition of the communication channel.

In order to ensure that the MCS is appropriate for the actual condition of the communication channel, Link Adaptation may be used in the related art.

FIG. 1 illustrates an example of Link Adaptation in the related art. As shown in FIG. 1, the base station and the UE transmit CSI-RS, CSI Report, and UL/DL data with MCS in the similar manner as explained above.

In this regard, in response to receiving the DL data with MCS (or instruction to transmit UL data with MCS), the UE may determine whether or not it can successfully receive and decode such DL data. If the UE can successfully receive and decode such DL data, the UE may then transmit a Hybrid Automatic Repeat request (HARQ) ACK back to the base station to indicate that the DL data with MCS are successfully received and decoded. If the UE cannot successfully receive and decode such DL data, the UE may then transmit a Hybrid Automatic Repeat request (HARQ) NACK back to the base station to indicate that the DL data with MCS are not successfully received and decoded.

The base station may then determine a Block Error Rate (BLER) based on the received ACK/NACK over time. The BLER may refer to an error rate specifying a number of erroneous transport blocks against a total number of transport blocks over time. The base station may then adapt the MCS based on the determined BLER, by decreasing the MCS if the BLER is too high, and vice versa.

Nevertheless, the above approach for Link Adaptation in the related art have the following short comings. In the related art, the base station may consider overall BLER for all time slots within the communication channel, and adapt the MCS for all time slots based on such overall BLER. However, each time slots may carry different kinds of data, which may result in different numbers of erroneous transport blocks, and subsequently different values of BLER. As such, the adjusted MCS may be appropriate for such overall BLER but not appropriate for a specific BLER of certain time slots within the communication channel, which reduces efficiency. Further, a small number of time slots may have a much higher BLER than other time slots within the communication channel, which may result in higher overall BLER (error rate) than reality.

### SUMMARY

Example embodiments of the present disclosure evaluate network conditions in a telecommunication network on a slot by slot basis. As such, example embodiments of the present disclosure improve the error rate and efficiency.

According to embodiments, a system is provided. The system may include: a memory storage storing computer-executable instructions; and at least one processor communicatively coupled to the memory storage, wherein the at least one processor may be configured to execute the instructions to: determine a condition of a communication channel during at least one time slot of a plurality of time slots; and adapt a transmission property of data during the at least one time slot based on the condition of the communication channel during a corresponding time slot.

According to embodiments, a method is provided. The method may include: determining a condition of a communication channel during at least one time slot of a plurality of time slots; and adapting a transmission property of data during the at least one time slot based on the condition of the communication channel during a corresponding time slot.

According to embodiments, a non-transitory computer-readable recording medium is provided. The non-transitory computer-readable recording medium may have recorded thereon instructions executable by at least one processor of a system to cause the at least one processor to perform a method including: determining a condition of a communication channel during at least one time slot of a plurality of time slots; and adapting a transmission property of data during the at least one time slot based on the condition of the communication channel during a corresponding time slot.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates an example of Link Adaptation in the related art.

FIG. 2 illustrates a block diagram of an example system configuration for evaluating network conditions, according to one or more embodiments.

FIG. 3 illustrates a block diagram of example components in a Network Condition Evaluating (NCE) system, according to one or more embodiments.

FIG. 4 illustrates a flow diagram of an example method for link adaptation, according to one or more embodiments.

FIG. 5 illustrates a flow diagram of an example method for adapting the transmission property, according to one or more embodiments.

FIG. 6 illustrates a diagram of an example environment in which systems and/or methods, described herein, may be implemented.

### DETAILED DESCRIPTION

The following detailed description of example embodiments refers to the accompanying drawings. The same reference numbers in different drawings may identify the same or similar elements.

The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Systems, methods, devices, and the like, provided in the example embodiments of the present disclosure evaluate network conditions in a telecommunication network on a slot by slot basis.

According to embodiments, the system may determine a condition of a communication channel during at least one time slot of a plurality of time slots; and adapt a transmission property of data during the at least one time slot based on the condition of the communication channel during a corresponding time slot. For example, based on determining that the condition exceeds at least one time threshold, the transmission property may be increased.

Ultimately, example embodiments of the present disclosure that evaluate network conditions in a telecommunication network on a slot by slot basis, improves error rate for DL and UL in the communication channel and improves efficiency.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the threshold tuning system of the present disclosure, according to one or more embodiments, are provided in the following.

### Example System Architecture

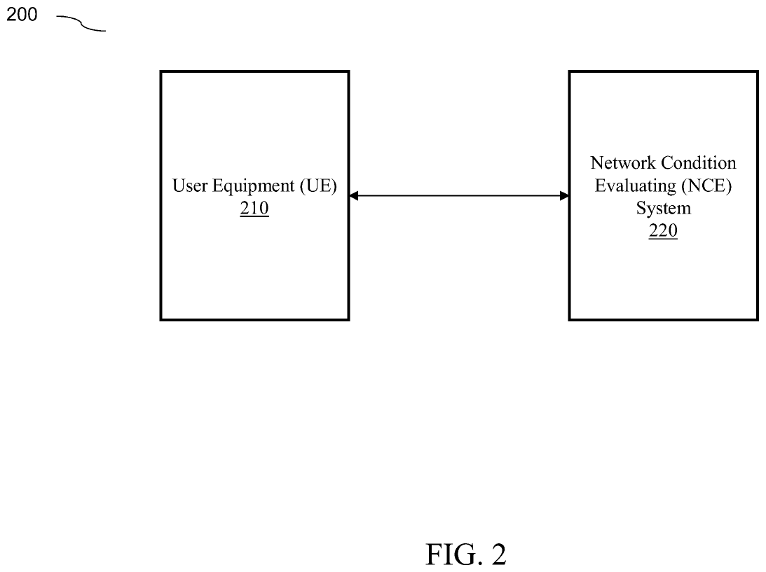

FIG. 2 illustrates a block diagram of an example system configuration 200 for evaluating network conditions, according to one or more embodiments. As illustrated in FIG. 2, system configuration 200 may include a user equipment (UE) 210 and a Network Condition Evaluating (NCE) system 220.

UE 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), a SIM-based device, or a similar device. UE 210 may be communicatively coupled to the NCE system 220. In some implementations, UE 210 may transmit UL data to the NCE system 220 and receive DL data from the NCE system 220.

NCE system 220 may include a system, a platform, a module, or the like, which may be configured to perform one or more operations or actions for evaluating network conditions. According to embodiments, the NCE system 220 may include a base station.

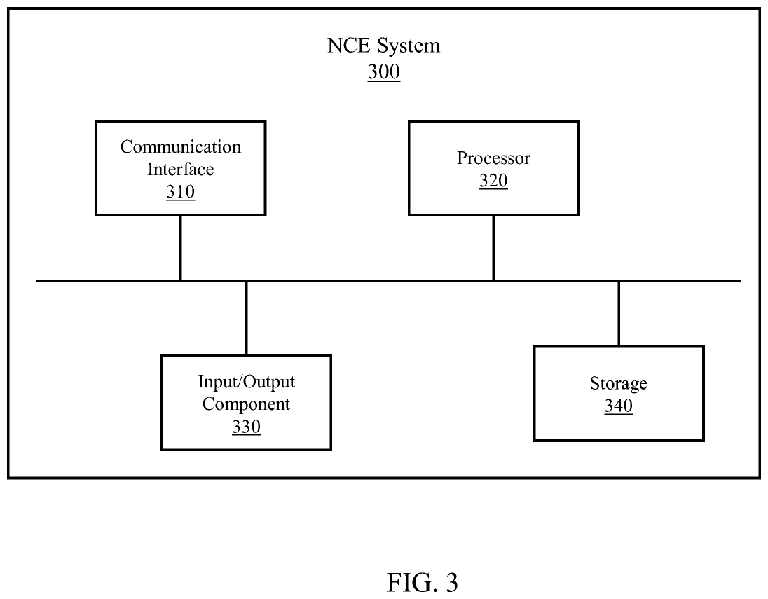

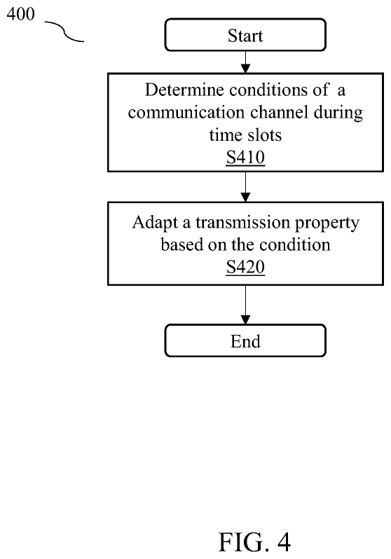

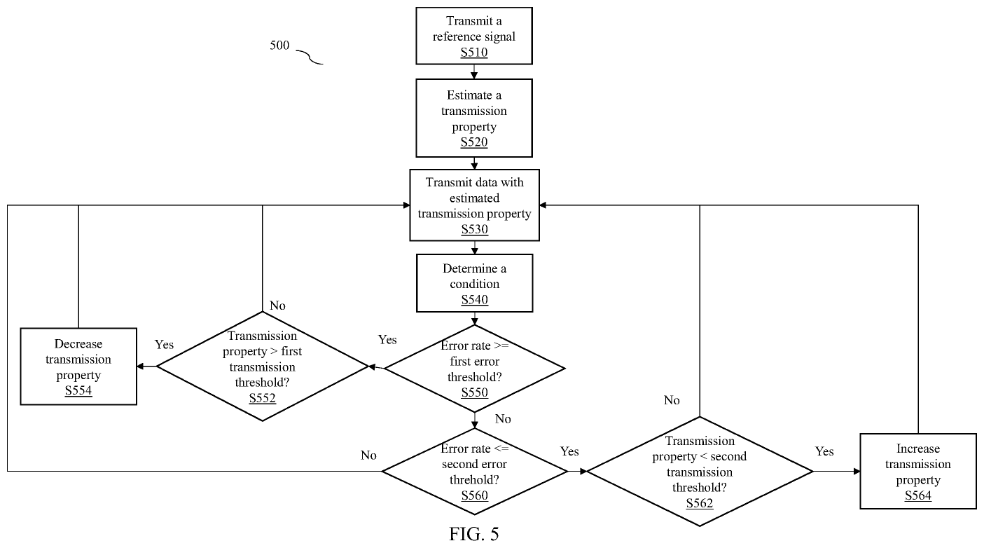

Example operations performable by the NCE system 220 for evaluating network conditions are described below with reference to FIG. 4 to FIG. 5. Further, several example components which may be included in the NCE system 220, according to one or more embodiments, are described below with reference to FIG. 3.

FIG. 3 illustrates a block diagram of example components in a NCE system 300, according to one or more embodiments. The NCE system 300 may corresponds to the NCE system 220 in FIG. 2, thus the features associated with the NCE system 220 and the NCE system 300 may be similarly applicable to each other, unless being explicitly described otherwise.

As illustrated in FIG. 3, the NCE system 300 may include at least one communication interface 310, at least one processor 320, at least one input/output component 330, and at least one storage 340, although it can be understood that the NCE system 300 may include more or less components than as illustrated in FIG. 3, and/or may be arranged in a manner different from as illustrated in FIG. 3, without departing from the scope of the present disclosure.

The communication interface 310 may include at least one transceiver-like component (e.g., a transceiver, a separate receiver and transmitter, a bus, etc.) that enables the components of the NCE system 300 to communicate with each other and/or to communicate with one or more components external to the NCE system 300, such as via a wired connection, a wireless connection, or a combination of wired and wireless connections.

For instance, the communication interface 310 may couple the processor 320 to the storage 340 to thereby enable them to communicate and to interoperate with each other in performing one or more operations. As another example, communication interface 310 may couple the NCE system 300 (or one or more components included therein) to the UE 210, so as to enable them to communicate and to interoperate with each other.

According to one or more embodiments, the communication interface 310 may include one or more application programming interfaces (APIs) which allow the NCE system 300 (or one or more components included therein) to communicate with one or more software applications (e.g., software application deployed in the UE 210, etc.).

The input/output component 330 may include at least one component that permits the NCE system 300 to receive information and/or to provide output information. It can be understood that, in some embodiments, the input/output component 330 may include at least one input component (e.g., a touch screen display, a button, a switch, a microphone, a sensor, etc.) and at least one output component (e.g., a display, a speaker, one or more light-emitting diodes (LEDs), etc.), each of which may be separated from each other.

The storage 340 may include one or more storage mediums suitable for storing data, information, and/or computer-executable instructions therein. According to embodiments, the storage 340 may include at least one memory storage, such as a random access memory (RAM), a read only memory (ROM), and/or another type of dynamic or static storage device (e.g., a flash memory, a magnetic memory, and/or an optical memory) that stores information and/or instructions for use by the processor 320. Additionally or alternatively, the storage 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 340 may be configured to store information, such as raw data, metadata, or the like, obtained from UE 210. Additionally or alternatively, the storage 340 may be configured to store one or more information associated with one or more operations performed by the processor 320. For instance, the storage 340 may store information defining the historical operation(s) performed by the processor 320 to evaluate network conditions, one or more results of operations performed by the processor 320, or the like. Further, the storage 340 may store data or information required in evaluating network conditions. For instance, the storage 340 may store at least one time thresholds and/or look up tables (described below with reference to FIG. 4 and FIG. 5).

In some implementation, the storage 340 may include a plurality of storage mediums, and the storage 340 may be configured to store a duplicate or a copy of at least a portion of the information in the plurality of storage mediums, for providing redundancy and for backing-up the information or the associated data. Furthermore, the storage 340 may also store computer-readable or computer-executable instructions which, when being executed by one or more processors (e.g., processor 320), causes the one or more processors to perform one or more actions/operations described herein

The processor 320 may include at least one processor capable of being programmed or being configured to perform a function(s) or an operation(s) described herein. For instance, the processor 320 may be configured to execute computer-executable instructions stored in at least one storage medium or a memory storage (e.g., storage 340, etc.) to thereby perform one or more actions or one or more operations described herein.

According to embodiments, the processor 320 may be configured to receive (e.g., via the communication interface 310, via the input/output component 330, etc.) one or more signals and/or one or more user inputs defining one or more instructions for performing one or more operations. Further, the processor 320 may be implemented in hardware, firmware, or a combination of hardware and software. For instance, processor 320 may include at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to embodiments, the processor 320 may be configured to collect, to extract, and/or to receive one or more information (in the form of signal or data, etc.) from the UE 210, and to process the received one or more information to thereby evaluate network conditions.

Descriptions of several example operations which may be performed by the processor 320 are provided below with reference to FIG. 4 to FIG. 5.

### Example Operations for Link Adaptation in the Present Disclosure

In the following, several example operations performable by the NCE system of the present disclosure are described with reference to FIG. 4 to FIG. 5. It can be understood that the example operations performable by the NCE system of the present disclosure can be performed under time division duplexing (TDD) or frequency division duplexing (FDD).

FIG. 4 illustrates a flow diagram of an example method 400 for link adaptation, according to one or more embodiments. One or more operations in method 400 may be performed by at least one processor (e.g., processor 320) of the NCE system.

As illustrated in FIG. 4, at operation S410, the at least one processor may be configured to determine the conditions of a communication channel with the UE during at least one time slots of a plurality of time slots.

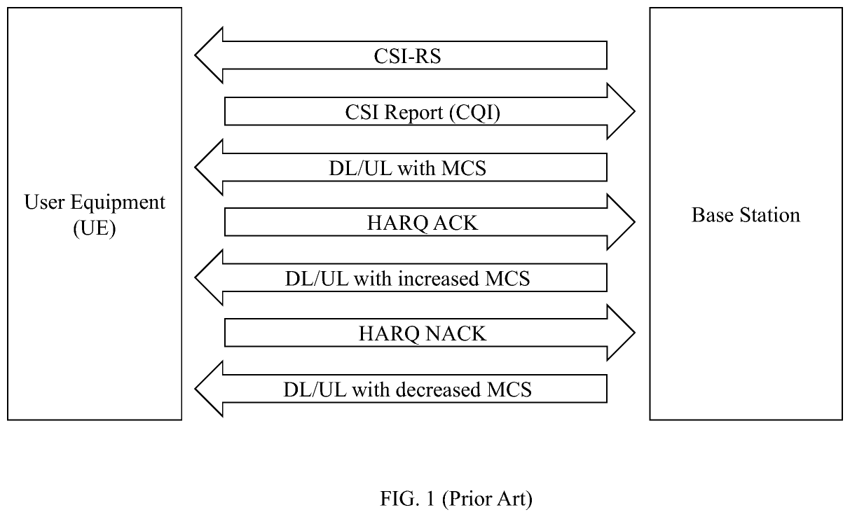

According to embodiments, the condition may be determined by determining an error rate, such as the Block Error Rate (BLER), during the at least one time slots. The BLER may refer to an error rate specifying a number of erroneous transport blocks against a total number of transport blocks over time. According to embodiments, the error rate may be determined based on signals received from the UE, such as the Hybrid Automatic Repeat request (HARQ) ACK and Hybrid Automatic Repeat request (HARQ) NACK, in the similar manner as explained in relation to FIG. 1. For example, the at least one processor may determine the BLER for time slot 3 based on the HARQ ACK/HARQ NACK received during time slot 3 over time. The method then proceeds to operation S420.

At operation S420, the at least one processor may be configured to adapt a transmission property of data during the at least one time slot based on the condition of the communication channel during a corresponding time slot.

According to embodiments, the transmission property may refer to a Modulation and Coding Scheme (MCS) specifying a modulation and coding rate for the data. The modulation may refer to a number of bits that is carried by a single resource element, and the code rate may refer to a number of used bits against a total number of bits, as understood by those skilled in the art. The correspondence between the MCS and the modulation and coding rate may be predetermined or preconfigured by one or more users (e.g., user(s) from a network operator, etc.) in a look up table. For example, the at least one processor may decrease the MCS for data transmission during time slot 3 in response to determining that BLER for time slot 3 is high, and may increase the MCS for data transmission during time slot 5 in response to determining that BLER for time slot 5 is low. Examples of operations for adapting the transmission property are described below with reference to FIG. 5.

Upon performing operation S420, the method 400 may be ended or be terminated. Alternatively, method 400 may return to operation S410, such that the at least one processor may be configured to repeatedly perform, for at least a predetermined amount of time, the determining the conditions of the communication channel (at operation S410) and the adapting the transmission property (at operation S420).

To this end, the system of the present disclosure may evaluate the condition of the communication channel on a slot by slot basis.

It can be understood that the configuration illustrated in FIG. 4 is simplified for descriptive purpose, and is not intended to limit the scope of the present disclosure in any way.

### Example Operations for Adapting the Transmission Property in the Present Disclosure

In the following several example operations performable by the at least one processor for adapting the transmission property are described with reference to FIG. 5.

FIG. 5 illustrates a flow diagram of an example method 500 for adapting the transmission property, according to one or more embodiments. One or more operations of method 500 may be part of operation S410 and/or S420 in method 400, and may be performed by at least one processor (e.g., processor 320) of the NCE system.

As illustrated in FIG. 5, at operation S510, the at least one processor may be configured to transmit a reference signal. The reference signal may include a Channel Status Information Reference Signal (CSI-RS). The method then proceeds to operation S520.

At operation S520, the at least one processor may be configured to estimate a transmission property for transmission of data between the NCE system and the UE. The transmission property may include a Modulation and Coding Scheme (MCS) specifying a modulation and coding rate for the data. The transmission property may be determined based on a first feedback received from the UE. The first feedback may include a Channel Status Information Report (CSI Report), which may include at least a Channel Quality Indicator (CQI) indicating a quality (condition) of the communication channel. The method then proceeds to operation S530.

At operation S530, the at least one processor may be configured to transmit data during one or more time slots of a plurality of time slots, where such data may have the estimated transmission property. For example, the at least one processor may be configured to transmit DL data having the modulation and coding rate corresponding to the estimated MCS during time slots 3 and 5 of a plurality of time slots.

At operation S540, the at least one processor may be configured to determine a condition of the communication channel during the one or more time slots by determining an error rate for transmitting the data having the estimated transmission property during the corresponding time slots. The error rate may include a Block Error Rate (BLER), and may be determined based on a second feedback received from the UE. The second feedback may include at least one of: a Hybrid Automatic Repeat request (HARQ) ACK indicating that the UE can successfully receive and decode the data having the estimated transmission property during the at least one time slots; and Hybrid Automatic Repeat request (HARQ) NACK indicating that the UE cannot successfully receive and decode the data having the estimated transmission property during the at least one time slots.

For example, the at least one processor may determine the BLER for time slot 3 based on the HARQ ACK/HARQ NACK received during time slot 3 (which indicate that the UE can\cannot successfully receive and decode the DL data having the estimated MCS during time slot 3). The method then proceeds to operation S550.

At operation S550, the at least one processor may be configured to determine whether or not the error rate for transmitting the data having the estimated transmission property during the at least one time slots is too high, by determining whether or not the error rate is greater than or equal to a first error threshold. The first error threshold may specify an upper limit for the error rate.

Accordingly, based on determining that the error rate for transmitting the data having the estimated transmission property during the at least one time slots is greater than or equal to a first error threshold, the at least one processor may determine that the error rate for transmitting the data having the estimated transmission property during the at least one time slots is too high, and proceeds to operation S552. On the other hand, based on determining that the error rate for transmitting the data having the estimated transmission property during the at least one time slots is not greater than or equal to a first error threshold, the at least one processor may determine that the error rate for transmitting the data having the estimated transmission property during the at least one time slots is not too high, and proceeds to operation S560.

At operation S552, the at least one processor may be configured to determine whether or not the transmission property for transmission of data during the at least one time slot can be further decreased to accommodate for the high error rate, by determining whether or not the transmission property is greater than a first transmission threshold. The first transmission threshold may specify a minimum value of the transmission property.

Accordingly, based on determining that the transmission property is greater than a first transmission threshold, the at least one processor may determine that the transmission property for transmission of data during the at least one time slot can be further decreased, and proceeds to operation S554. On the other hand, based on determining that the transmission property is not greater than a first transmission threshold, the at least one processor may determine that the transmission property for transmission of data during the at least one time slot cannot be further decreased, and returns to operation S530 to continue to transmit data having the transmission property.

At operation S554, the at least one processor may be configured to adapt the transmission property for transmission of data during the at least one time slot, by decreasing the transmission property to accommodate for the high error rate. The method then returns to operation S530 to transmit data having the decreased transmission property.

For example, the at least one processor may be configured to decrease the MCS for transmission of DL data during time slot 3 in response to determining that the BLER for time slot 3 is greater than or equal to the upper limit of the error rate and that the MCS for transmission of DL data during time slot 3 is greater than the minimum value of the MCS.

At operation S560, the at least one processor may be configured to determine whether or not the error rate for transmitting the data having the estimated transmission property during the at least one time slots is too low, by determining whether or not the error rate is lower than or equal to a second error threshold. The second error threshold may specify a lower limit for the error rate.

Accordingly, based on determining that the error rate for transmitting the data having the estimated transmission property during the at least one time slots is lower than or equal to a second error threshold, the at least one processor may determine that the error rate for transmitting the data having the estimated transmission property during the at least one time slots is too low, and proceeds to operation S562. On the other hand, based on determining that the error rate for transmitting the data having the estimated transmission property during the at least one time slots is not lower than or equal to a second error threshold, the at least one processor may determine that the error rate for transmitting the data having the estimated transmission property during the at least one time slots is not too low, and returns to operation S530 to continue to transmit data having the transmission property.

At operation S562, the at least one processor may be configured to determine whether or not the transmission property for transmission of data during the at least one time slot can be further increased to accommodate for the low error rate, by determining whether or not the transmission property is lower than a second transmission threshold. The second transmission threshold may specify a maximum value of the transmission property.

Accordingly, based on determining that the transmission property is lower than a second transmission threshold, the at least one processor may determine that the transmission property for transmission of data during the at least one time slot can be further increased, and proceeds to operation S564. On the other hand, based on determining that the transmission property is not lower than a second transmission threshold, the at least one processor may determine that the transmission property for transmission of data during the at least one time slot cannot be further increased, and returns to operation S530 to continue to transmit data having the transmission property.

At operation S564, the at least one processor may be configured to adapt the transmission property for transmission of data during the at least one time slot, by increasing the transmission property to accommodate for the low error rate. The method then returns to operation S530 to transmit data having the increased transmission property.

For example, the at least one processor may be configured to increase the MCS for transmission of DL data during time slot 5 in response to determining that the BLER for time slot 5 is lower than or equal to the lower limit of the error rate and that the MCS for transmission of DL data during time slot 5 is lower than the maximum value of the MCS.

It may be understood that the first error threshold, the second error threshold, the first transmission threshold, and the second transmission threshold are predetermined or preconfigured by one or more users (e.g., user(s) from a network operator, etc.). It may also be understood that the correspondence between the MCS and the modulation and coding rate, as well as the increase and decrease of MCS, may be predetermined or preconfigured by one or more users (e.g., user(s) from a network operator, etc.) in a look up table.

After operations S554 and S564, the method returns to operations S530, S540, S550, S552, S560, and S562 and repeat said operations, in order to continue to check the condition of the communication channel and increase/decrease the transmission property as the error rate continues to be lower or higher than the upper or lower limits.

Although the above example operations for adapting the transmission property is described in relation to transmission of DL data having the transmission property to the UE, it can be understood that similar operations can be performed in relation to transmission of instructions to the UE to transmit data having the transmission property without departing from the scope of the present disclosure.

### Example Implementation Environment

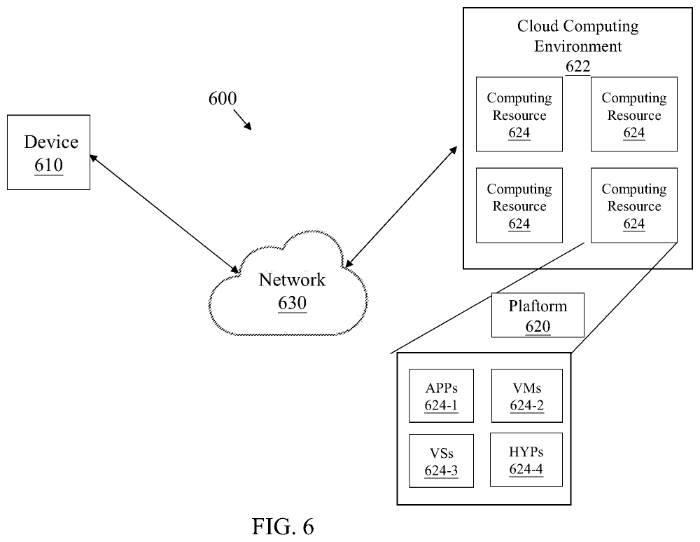

FIG. 6 illustrates a diagram of an example environment 600 in which systems and/or methods, described herein, may be implemented. As shown in FIG. 6, environment 600 may include a device 610, a platform 620, and a network 630. Devices of environment 600 may interconnect via wired connections, wireless connections, or a combination of wired and wireless connections. In some embodiments, any of the functions and operations described with reference to FIG. 2 to FIG. 5 above may be performed by any combination of elements illustrated in FIG. 6.

According to embodiments, the NCE system described herein may be stored, hosted, or deployed in the cloud computing platform 620. In this regard, device 610 may include a device, system, equipment, or the like, utilized by the user (e.g., user of a marketing team, user of a network planning team, etc.) to access the NCE system. In that case, device 610 may include one or more devices capable of receiving, generating, storing, processing, and/or providing information associated with platform 620. According to embodiments, device 610 may be UE 210 in FIG. 2.

Platform 620 includes one or more devices capable of receiving, generating, storing, processing, and/or providing information. In some implementations, platform 620 may include a cloud server or a group of cloud servers. In some implementations, platform 620 may be designed to be modular such that certain software components may be swapped in or out depending on a particular need. As such, platform 620 may be easily and/or quickly reconfigured for different uses.

In some implementations, as shown, platform 620 may be hosted in cloud computing environment 622. Notably, while implementations described herein describe platform 620 as being hosted in cloud computing environment 622, in some implementations, platform 620 may not be cloud-based (i.e., may be implemented outside of a cloud computing environment) or may be partially cloud-based.

Cloud computing environment 622 includes an environment that hosts platform 620. Cloud computing environment 622 may provide computation, software, data access, storage, etc. services that do not require end-user (e.g., user device 610) knowledge of a physical location and configuration of system(s) and/or device(s) that hosts platform 620. As shown, cloud computing environment 622 may include a group of computing resources 624 (referred to collectively as “computing resources 624” and individually as “computing resource 624”).

Computing resource 624 includes one or more personal computers, a cluster of computing devices, workstation computers, server devices, or other types of computation and/or communication devices. In some implementations, computing resource 624 may host platform 620. The cloud resources may include compute instances executing in computing resource 624, storage devices provided in computing resource 624, data transfer devices provided by computing resource 624, etc. In some implementations, computing resource 624 may communicate with other computing resources 624 via wired connections, wireless connections, or a combination of wired and wireless connections.

As further shown in FIG. 6, computing resource 624 includes a group of cloud resources, such as one or more applications (“APPs”) 624-1, one or more virtual machines (“VMs”) 624-2, virtualized storage (“VSs”) 624-3, one or more hypervisors (“HYPs”) 624-4, or the like.

Application 624-1 includes one or more software applications that may be provided to or accessed by user device 610. Application 624-1 may eliminate a need to install and execute the software applications on user device 610. For example, application 624-1 may include software associated with platform 620 and/or any other software capable of being provided via cloud computing environment 622. In some implementations, one application 624-1 may send/receive information to/from one or more other applications 624-1, via virtual machine 624-2.

Virtual machine 624-2 includes a software implementation of a machine (e.g., a computer) that executes programs like a physical machine. Virtual machine 624-2 may be either a system virtual machine or a process virtual machine, depending upon use and degree of correspondence to any real machine by virtual machine 624-2. A system virtual machine may provide a complete system platform that supports execution of a complete operating system (“OS”). A process virtual machine may execute a single program, and may support a single process. In some implementations, virtual machine 624-2 may execute on behalf of a user (e.g., user device 610), and may manage infrastructure of cloud computing environment 622, such as data management, synchronization, or long-duration data transfers.

Virtualized storage 624-3 includes one or more storage systems and/or one or more devices that use virtualization techniques within the storage systems or devices of computing resource 624. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 624-4 may provide hardware virtualization techniques that allow multiple operating systems (e.g., “guest operating systems”) to execute concurrently on a host computer, such as computing resource 624. Hypervisor 624-4 may present a virtual operating platform to the guest operating systems, and may manage the execution of the guest operating systems. Multiple instances of a variety of operating systems may share virtualized hardware resources.

Network 630 may include one or more wired and/or wireless networks. For example, network 630 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

### Various Aspects of Embodiments

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:
Item [1]: A system that may include: a memory storage storing computer-executable instructions; and at least one processor communicatively coupled to the memory storage, wherein the at least one processor may be configured to execute the instructions to: determine a condition of a communication channel during at least one time slot of a plurality of time slots; and adapt a transmission property of data during the at least one time slot based on the condition of the communication channel during a corresponding time slot.
Item [2]: The system according to item [1], wherein the at least one processor may be configured to execute the instructions to determine the condition by determining an error rate of the at least one time slot.
Item [3]: The system according to item [2], wherein the at least one processor may be configured to execute the instructions to adapt the transmission property by: in response to determining that the error rate is greater than or equal to a first error threshold and to determining that the transmission property is greater than a first transmission threshold, decreasing the transmission property; and in response to determining that the error rate is less than or equal to a second error threshold and to determining that the transmission property is less than a second transmission threshold, increasing the transmission property.
Item [4]: The system according to item [3], wherein: the transmission property may include a Modulation and Coding Scheme (MCS); the memory may include a look up table specifying a correspondence between the MCS and a modulation and code rate for transmission of the data; the at least one processor may be configured to execute the instructions to decrease the transmission property by, decreasing the modulation and code rate for transmission of the data based on the look up table; and the at least one processor may be configured to execute the instructions to increase the transmission property by, increasing the modulation and code rate for transmission of the data based on the look up table.
Item [5]: The system according to item [4], wherein the error rate may specify a number of erroneous transport blocks against a total number of transport blocks over time; wherein the modulation may specify a number of bits that is carried by a single resource element; and wherein the code rate may specify a number of used bits against a total number of bits.
Item [6]: The system according to any one of items [3]-[5], wherein the first error threshold, the second error threshold, the first transmission threshold, and the second transmission threshold may be predetermined.
Item [7]: The system according to items [1]-[6], wherein the at least one processor may be configured to execute the instructions to: transmit a reference signal to a user equipment; estimate the transmission property based on a first feedback received from the user equipment; at least one of transmit the data having the estimated transmission property to the user equipment during the at least one time slot, and transmit an instruction to the user equipment to transmit the data having the estimated transmission property during the at least one time slot; determine the condition of the communication channel during the at least one time slot based on a second feedback received from the user equipment; and at least one of transmit the data having the adapted transmission property to the user equipment during the at least one time slot, and transmit an instruction to the user equipment to transmit the data having the adapted transmission property during the at least one time slot.
Item [8]: The system according to item [7], wherein: the reference signal may include a Channel Status Information Reference Signal (CSI-RS); the first feedback may include a Channel Status Information Report (CSI Report); the transmission property may include a Modulation and Coding Scheme (MCS); the condition may include a Block Error Rate (BLER); and the second feedback may include at least one of a HARQ ACK signal and a HARQ NACK signal.
Item [9]: A method that may include: determining a condition of a communication channel during at least one time slot of a plurality of time slots; and adapting a transmission property of data during the at least one time slot based on the condition of the communication channel during a corresponding time slot.
Item [10]: The method according to item [9], wherein the determining the condition may include determining an error rate of the at least one time slot.
Item [11]: The method according to item [10], wherein the adapting the transmission property may include: in response to determining that the error rate is greater than or equal to a first error threshold and to determining that the transmission property is greater than a first transmission threshold, decreasing the transmission property; and in response to determining that the error rate is less than or equal to a second error threshold and to determining that the transmission property is less than a second transmission threshold, increasing the transmission property.
Item [12]: The method according to item [11], wherein: the transmission property may include a Modulation and Coding Scheme (MCS); the method is performed by a system having a memory that may include a look up table specifying a correspondence between the MCS and a modulation and code rate for transmission of the data; the decreasing the transmission property may include decreasing the modulation and code rate for transmission of the data based on the look up table; and the increasing the transmission property may include increasing the modulation and code rate for transmission of the data based on the look up table.
Item [13]: The method according to item [12], wherein the error rate may specify a number of erroneous transport blocks against a total number of transport blocks over time; wherein the modulation may specify a number of bits that is carried by a single resource element; and wherein the code rate may specify a number of used bits against a total number of bits.
Item [14]: The method according to any one of items [11]-[13], wherein the first error threshold, the second error threshold, the first transmission threshold, and the second transmission threshold may be predetermined.
Item [15]: The method according to any one of items [9]-[14], may include: transmitting a reference signal to a user equipment; estimating the transmission property based on a first feedback received from the user equipment; at least one of transmitting the data having the estimated transmission property to the user equipment during the at least one time slot, and transmitting an instruction to the user equipment to transmit the data having the estimated transmission property during the at least one time slot; determining the condition of the communication channel during the at least one time slot based on a second feedback received from the user equipment; and at least one of transmitting the data having the adapted transmission property to the user equipment during the at least one time slot, and transmitting an instruction to the user equipment to transmit the data having the adapted transmission property during the at least one time slot.
Item [16]: The method according to item [15], wherein: the reference signal may include a Channel Status Information Reference Signal (CSI-RS); the first feedback may include a Channel Status Information Report (CSI Report); the transmission property may include a Modulation and Coding Scheme (MCS); the condition may include a Block Error Rate (BLER); and the second feedback may include at least one of a HARQ ACK signal and a HARQ NACK signal.
Item [17]: A non-transitory computer-readable recording medium that may have recorded thereon instructions executable by at least one processor of a system to cause the at least one processor to perform a method including: determining a condition of a communication channel during at least one time slot of a plurality of time slots; and adapting a transmission property of data during the at least one time slot based on the condition of the communication channel during a corresponding time slot.
Item [18]: The non-transitory computer-readable recording medium according to item [17], wherein the determining the condition may include determining an error rate of the at least one time slot.
Item [19]: The non-transitory computer-readable recording medium according to item [18], wherein the adapting the transmission property may include: in response to determining that the error rate is greater than or equal to a first error threshold and to determining that the transmission property is greater than a first transmission threshold, decreasing the transmission property; and in response to determining that the error rate is less than or equal to a second error threshold and to determining that the transmission property is less than a second transmission threshold, increasing the transmission property.
Item [20]: The non-transitory computer-readable recording medium according to item [19], wherein: the transmission property may include a Modulation and Coding Scheme (MCS); the method is performed by a system having a memory that may include a look up table specifying a correspondence between the MCS and a modulation and code rate for transmission of the data; the decreasing the transmission property may include decreasing the modulation and code rate for transmission of the data based on the look up table; and the increasing the transmission property may include increasing the modulation and code rate for transmission of the data based on the look up table.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A system comprising:
a memory storage storing computer-executable instructions; and
at least one processor communicatively coupled to the memory storage, wherein the at least one processor is configured to execute the instructions to:
determine a condition of a communication channel during at least one time slot of a plurality of time slots; and
adapt a transmission property of data during the at least one time slot based on the condition of the communication channel during a corresponding time slot.

2. The system according to claim 1, wherein the at least one processor is configured to execute the instructions to determine the condition by determining an error rate of the at least one time slot.

3. The system according to claim 2, wherein the at least one processor is configured to execute the instructions to adapt the transmission property by:
in response to determining that the error rate is greater than or equal to a first error threshold and to determining that the transmission property is greater than a first transmission threshold, decreasing the transmission property; and
in response to determining that the error rate is less than or equal to a second error threshold and to determining that the transmission property is less than a second transmission threshold, increasing the transmission property.

4. The system according to claim 3, wherein:
the transmission property comprises a Modulation and Coding Scheme (MCS);
the memory comprises a look up table specifying a correspondence between the MCS and a modulation and code rate for transmission of the data;
the at least one processor is configured to execute the instructions to decrease the transmission property by, decreasing the modulation and code rate for transmission of the data based on the look up table; and
the at least one processor is configured to execute the instructions to increase the transmission property by, increasing the modulation and code rate for transmission of the data based on the look up table.

5. The system according to claim 4, wherein the error rate specifies a number of erroneous transport blocks against a total number of transport blocks over time; wherein the modulation specifies a number of bits that is carried by a single resource element; and
wherein the code rate specifies a number of used bits against a total number of bits.

6. The system according to claim 3, wherein the first error threshold, the second error threshold, the first transmission threshold, and the second transmission threshold are predetermined.

7. The system according to claim 1, wherein the at least one processor is configured to execute the instructions to:
transmit a reference signal to a user equipment;
estimate the transmission property based on a first feedback received from the user equipment;
at least one of transmit the data having the estimated transmission property to the user equipment during the at least one time slot, and transmit an instruction to the user equipment to transmit the data having the estimated transmission property during the at least one time slot;
determine the condition of the communication channel during the at least one time slot based on a second feedback received from the user equipment; and
at least one of transmit the data having the adapted transmission property to the user equipment during the at least one time slot, and transmit an instruction to the user equipment to transmit the data having the adapted transmission property during the at least one time slot.

8. The system according to claim 7, wherein:
the reference signal comprises a Channel Status Information Reference Signal (CSI-RS);
the first feedback comprises a Channel Status Information Report (CSI Report);
the transmission property comprises a Modulation and Coding Scheme (MCS);
the condition comprises a Block Error Rate (BLER); and
the second feedback comprises at least one of a HARQ ACK signal and a HARQ NACK signal.

9. A method, comprising:
determining a condition of a communication channel during at least one time slot of a plurality of time slots; and
adapting a transmission property of data during the at least one time slot based on the condition of the communication channel during a corresponding time slot.

10. The method according to claim 9, wherein the determining the condition comprises determining an error rate of the at least one time slot.

11. The method according to claim 10, wherein the adapting the transmission property comprises:
in response to determining that the error rate is greater than or equal to a first error threshold and to determining that the transmission property is greater than a first transmission threshold, decreasing the transmission property; and
in response to determining that the error rate is less than or equal to a second error threshold and to determining that the transmission property is less than a second transmission threshold, increasing the transmission property.

12. The method according to claim 11, wherein:
the transmission property comprises a Modulation and Coding Scheme (MCS);
the method is performed by a system having a memory that comprises a look up table specifying a correspondence between the MCS and a modulation and code rate for transmission of the data;
the decreasing the transmission property comprises decreasing the modulation and code rate for transmission of the data based on the look up table; and
the increasing the transmission property comprises increasing the modulation and code rate for transmission of the data based on the look up table.

13. The method according to claim 12, wherein the error rate specifies a number of erroneous transport blocks against a total number of transport blocks over time; wherein the modulation specifies a number of bits that is carried by a single resource element; and
wherein the code rate specifies a number of used bits against a total number of bits.

14. The method according to claim 11, wherein the first error threshold, the second error threshold, the first transmission threshold, and the second transmission threshold are predetermined.

15. The method according to claim 9, further comprising:
transmitting a reference signal to a user equipment;
estimating the transmission property based on a first feedback received from the user equipment;
at least one of transmitting the data having the estimated transmission property to the user equipment during the at least one time slot, and transmitting an instruction to the user equipment to transmit the data having the estimated transmission property during the at least one time slot;
determining the condition of the communication channel during the at least one time slot based on a second feedback received from the user equipment; and
at least one of transmitting the data having the adapted transmission property to the user equipment during the at least one time slot, and transmitting an instruction to the user equipment to transmit the data having the adapted transmission property during the at least one time slot.

16. The method according to claim 15, wherein:
the reference signal comprises a Channel Status Information Reference Signal (CSI-RS);
the first feedback comprises a Channel Status Information Report (CSI Report);
the transmission property comprises a Modulation and Coding Scheme (MCS);
the condition comprises a Block Error Rate (BLER); and
the second feedback comprises at least one of a HARQ ACK signal and a HARQ NACK signal.

17. A non-transitory computer-readable recording medium having recorded thereon instructions executable by at least one processor to cause the at least one processor to perform a method comprising:
determining a condition of a communication channel during at least one time slot of a plurality of time slots; and
adapting a transmission property of data during the at least one time slot based on the condition of the communication channel during a corresponding time slot.

18. The non-transitory computer-readable recording medium according to claim 17, wherein the determining the condition comprises determining an error rate of the at least one time slot.

19. The non-transitory computer-readable recording medium according to claim 18, wherein the adapting the transmission property comprises:
in response to determining that the error rate is greater than or equal to a first error threshold and to determining that the transmission property is greater than a first transmission threshold, decreasing the transmission property; and
in response to determining that the error rate is less than or equal to a second error threshold and to determining that the transmission property is less than a second transmission threshold, increasing the transmission property.

20. The non-transitory computer-readable recording medium according to claim 19, wherein:
the transmission property comprises a Modulation and Coding Scheme (MCS);
the medium comprises a look up table specifying a correspondence between the MCS and a modulation and code rate for transmission of the data;
the decreasing the transmission property comprises decreasing the modulation and code rate for transmission of the data based on the look up table; and
the increasing the transmission property comprises increasing the modulation and code rate for transmission of the data based on the look up table.
